(19) United States
(12) Patent Application Publication
(10) Pub. No.: US 2004/0028570 A1
(43) Pub. Date: Feb. 12, 2004

(54) Modular endothermic gas generator system and method

(75) Inventors: Wallace J. Titus, Toledo, OH (US); Madhu P. Bhatnagar, Novi, MI (US); Joseph A. Kozma III, Canton, MI (US); John A. Lutz, Canton, MI (US)

Correspondence Address: BAKER BOTTS L.L.P., 2001 ROSS AVENUE, SUITE 600, DALLAS, TX, 75201-2980, US

(73) Assignee: AFC-Holcroft

(21) Appl. No.: 10/214,880

(22) Filed: Aug. 8, 2002

(51) Int. Cl. G05D 7/00

(52) U.S. Cl. 422/111; 422/198; 422/204; 48/119; 48/120; 48/123; 48/124; 48/126

(57) ABSTRACT

According to one embodiment of the invention, a gas generator system includes a combustion chamber having an insulation coupled to an inside surface thereof, a retort having a catalyst therein disposed within the combustion chamber, and an access door coupled to a side of the combustion chamber. The access door allows removal of the retort from the side of the combustion chamber. According to another embodiment of the invention, a gas generator system includes a combustion chamber having an insulation coupled to an inside surface thereof, a retort having a catalyst therein disposed within the combustion chamber, and a recuperator disposed proximate an open bottom of the combustion chamber. The recuperator prevents secondary combustion air from traveling in a direct path into the combustion chamber from outside the open bottom of the combustion chamber and raises the temperature of the secondary combustion air.

### TECHNICAL FIELD OF THE INVENTION

The present invention relates generally to the field of gas generators and, more particularly, to a modular endothermic gas generator system and method.

### BACKGROUND OF THE INVENTION

Endothermic gas generators have been around for quite some time. A gas generator typically has one or more retorts within a combustion chamber. Each retort has some type of catalyst within its body that reacts with gas flowing therethrough so that a desired chemistry may be obtained. Retorts are periodically removed from the combustion chamber for maintenance or replacement. In existing gas generators, the retorts are removed from the top of the combustion chamber, which required enough space between the top of the gas generator and the ceiling of the building that the gas generator resides in. Accordingly, an overhead crane is required to remove the retort from the combustion chamber. Therefore, a few problems with having to remove the retort from the top of the combustion chamber are that enough clearance space is needed above the gas generator and an overhead crane is required to remove the retort.

Existing gas generators are also somewhat inefficient because of the ring burner associated therewith. This is because ambient air entering the combustion chamber from the bottom of the combustion chamber enters at ambient temperature. Gas generators are also inefficient for the reason that constant speed pumps are used for each gas generator. This means that if the full capacity of the generator is not required then a governor associated with the header of the gas generator has to cut back some of the gas flow. Typically, only about 30% is cut back. More cutback above and beyond 30% is possible, but then the quality of the chemistry of the gas deteriorates. A variable speed pump has been used on a prior gas generator that had a plurality of retorts within a combustion chamber. However, this variable speed pump could only cut back about 50% of the gas flow through each of the retorts. If less gas flow was required, then the variable speed pump would have to turn down the flow on each of the retorts the same amount. This caused inefficient operation of the gas generator.

### SUMMARY OF THE INVENTION

According to one embodiment of the invention, a gas generator system includes a combustion chamber having an insulation coupled to an inside surface thereof, a retort having a catalyst therein disposed within the combustion chamber, and an access door coupled to a side of the combustion chamber. The access door allows removal of the retort from the side of the combustion chamber.

According to another embodiment of the invention, a gas generator system includes a combustion chamber having an insulation coupled to an inside surface thereof, a retort having a catalyst therein disposed within the combustion chamber, and a recuperator disposed proximate an open bottom of the combustion chamber. The recuperator prevents secondary combustion air from traveling in a direct path into the combustion chamber from outside the open bottom of the combustion chamber and raises the temperature of the secondary combustion air.

According to another embodiment of the invention, a method of controlling an output for a plurality of gas generators includes providing the gas generators in series, providing a single retort within each of the gas generators, associating a single variable speed pump with each of the gas generators, associating a single controller with all of the variable speed pumps, utilizing the single controller to change the output of a first gas generator via its respective variable speed pump, and utilizing the single controller, after the output of the first gas generator has been reduced to 20 percent output, to change the output of a second gas generator via its respective variable speed pump.

According to another embodiment of the invention, a method of cooling a gas mixture exiting a gas generator includes providing a heat exchanger on a top of a combustion chamber of the gas generator, in which the heat exchanger includes a chamber and a plurality of fin tubes surrounding the chamber, delivering the gas mixture upward into the chamber, directing the gas downward through the fin tubes, and directing ambient air by a fan over an exterior surface of each fin tube to cool the gas mixture.

Embodiments of the invention provide a number of technical advantages. Embodiments of the invention may include all, some, or none of these advantages. In one embodiment, a hinged retort access door allows removal of the retort from a side of the generator, which eliminates the need to remove the retort from the top of the generator. This greatly improves time and costs associated with maintenance, saves important shop space, and eliminates the need for an overhead crane. An endothermic gas generator manufactured according to one embodiment of the invention is more efficient than previous gas generators. For example, a recuperator is used at the bottom of the combustion chamber to heat ambient air before it enters the combustion chamber. This increases the efficiency of the ring burner as well as decreases the drafting effect when the ring burner is off. Another advantage of one embodiment of the present invention is that individual variable speed mixing pumps are utilized for a plurality of endothermic gas generators that are utilized in tandem. A master operator interface allows an operator to control turn-down profiles of the gas generators. In addition, a 5:1 turn-down ratio of the gas generators may be achieved. The master operator also facilitates the adding of additional gas generator modules if more output is required. This reduces capital costs for users and helps to run the gas generators more efficiently. Another advantage of one embodiment of the present invention is the use of a heat exchanger that provides a means for cleaning soot from the fin tubes and from the bottom manifold of the heat exchanger.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIG. 1 is a perspective view of an endothermic gas generator according to one embodiment of the present invention;

FIG. 2 is a perspective view of the gas generator of FIG. 1 illustrating a retort being removed from a side of the gas generator by utilizing an access door according to one embodiment of the present invention;

FIG. 3A is a front perspective view of the gas generator of FIG. 1 showing a ring burner and recuperator according to one embodiment of the present invention;

FIG. 3B is an elevation view of the recuperator of FIG. 3A;

FIG. 4 is a perspective view of a heat exchanger for use with the gas generator of FIG. 1 according to one embodiment of the present invention;

FIG. 5 is a perspective view of a plurality of endothermic gas generators each having a variable speed mixing pump according to another embodiment of the present invention; and

FIG. 6 is a flowchart illustrating a method of controlling the output for a plurality of gas generators according to one embodiment of the present invention.

### DETAILED DESCRIPTION OF EXAMPLE EMBODIMENTS OF THE INVENTION

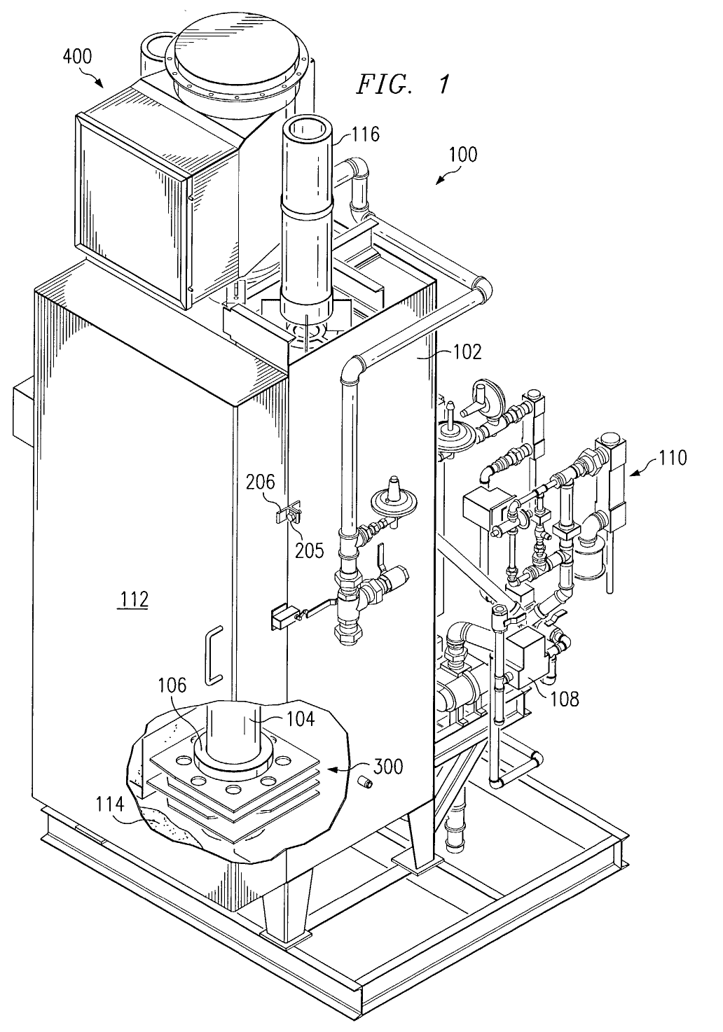

Example embodiments of the present invention and their advantages are best understood by referring now to FIGS. 1 through 6 of the drawings, in which like numerals refer to like parts.

FIG. 1 is a perspective view of an endothermic gas generator 100 according to one embodiment of the present invention. As illustrated in FIG. 1, gas generator 100 includes a combustion chamber 102, a retort 104, a ring burner 106, a recuperator 300, a variable speed pump 108, a process system 110, and a heat exchanger 400. Gas generator 100, in one embodiment, has a capacity of approximately 3,000 standard cubic feet per hour (“scfh”); however, gas generator 100 may have any suitable capacity depending on its intended use.

Combustion chamber 102 is illustrated in FIG. 1 to be a generally vertical rectangular box; however, combustion chamber 102 may be other suitable shapes. Combustion chamber 102, in one embodiment, is formed from a mild steel approximately one-quarter inch thick; however, combustion chamber 102 may be formed from other suitable materials in other suitable thicknesses. Combustion chamber 102 in conjunction with insulation 114 on an inside surface thereof functions to concentrate heat that is delivered to its interior onto retort 104 so that gas flowing through retort 104 is heated to a desired temperature. In other words, combustion chamber 102 functions much like an oven in that heated air delivered to its interior is used to heat its contents. The combustion products within combustion chamber 102 exhausts out of an exhaust 116 disposed on the top of combustion chamber 102. Insulation 114, in one embodiment, are modules of refractory ceramic fiber that come in one-foot cubes; however, insulation 114 may take on other suitable forms, such as eight pound density alumina-silica blanket. Any suitable thickness may be used for insulation 114, dependent upon the insulation material used. In addition, insulation 114 may be coupled to the inside of combustion chamber 102 in any suitable manner.

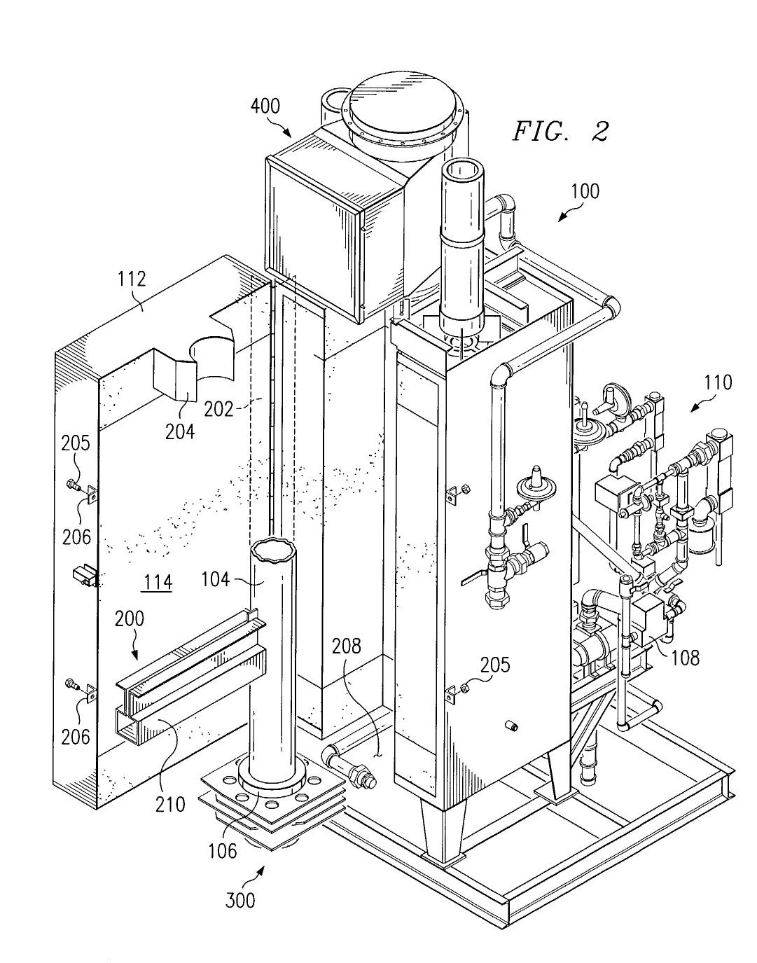

Combustion chamber 102 also includes an access door 112. According to the teachings of one embodiment of the present invention, access door 112 is coupled to a side of combustion chamber 102 and is adapted to allow removal of retort 104 from the side of combustion chamber 102. One technical advantage of being able to remove retort 104 through a side of combustion chamber 102 via access door 112 is that less space is needed over gas generator 100, which reduces the clearance requirements for the roof of any structure that gas generator 100 resides in. Also, not having to remove retort 104 from a top of generator 100 eliminates the need to have an overhead crane available to remove retort 104. As such, gas generator 100 is much easier and less expensive to maintain than previous gas generators. Access door 112 is described in more detail below in conjunction with FIG. 2.

Retort 104 is illustrated in FIG. 1 to be a generally elongated cylinder with a height of approximately nine and one-half feet; however, retort 104 may be formed from other suitable structures having any suitable configuration and any suitable length. Retort 104 has catalyst disposed therein (not explicitly shown) that functions to change the chemistry of gas flowing through the interior of retort 104 to produce the desired resultant gas. Catalyst contained in retort 104 may be any suitable reaction catalyst used in gas generators.

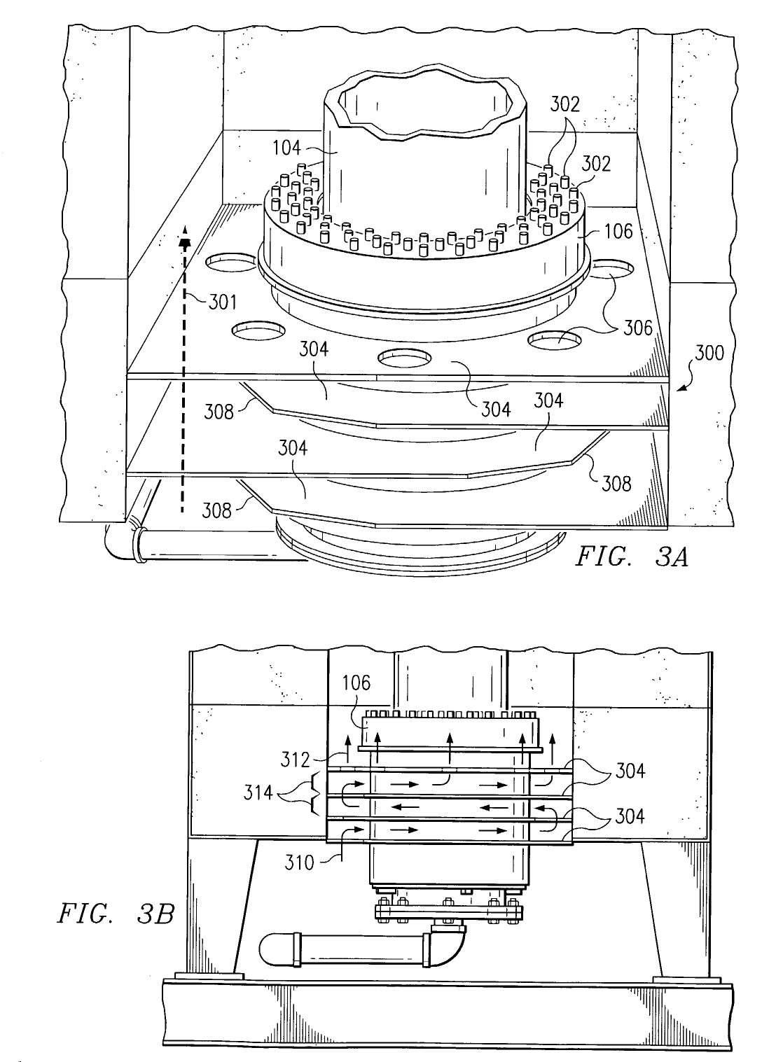

Details of ring burner 106 are discussed in further detail below in conjunction with FIGS. 3A and 3B. Generally, pre-mixed natural gas and air is delivered to ring burner 106 and a spark ignites the mixture to produce flames that heat the interior of combustion chamber 102 so that retort 104 may be heated. Ring burner 106 may be formed from any suitable heat-resistant material and may have any suitable configuration.

Recuperator 300 is also described in greater detail below in conjunction with FIGS. 3A and 3B. According to the teachings of another embodiment of the present invention, recuperator 300 is adapted to preheat ambient air traveling into the interior of combustion chamber 102 to a temperature of at least approximately 600° F. As described further below, one way that recuperator 300 facilitates this preheating is to prevent the ambient air from traveling in a direct path into the interior of combustion chamber 102 from outside an open bottom of combustion chamber 102.

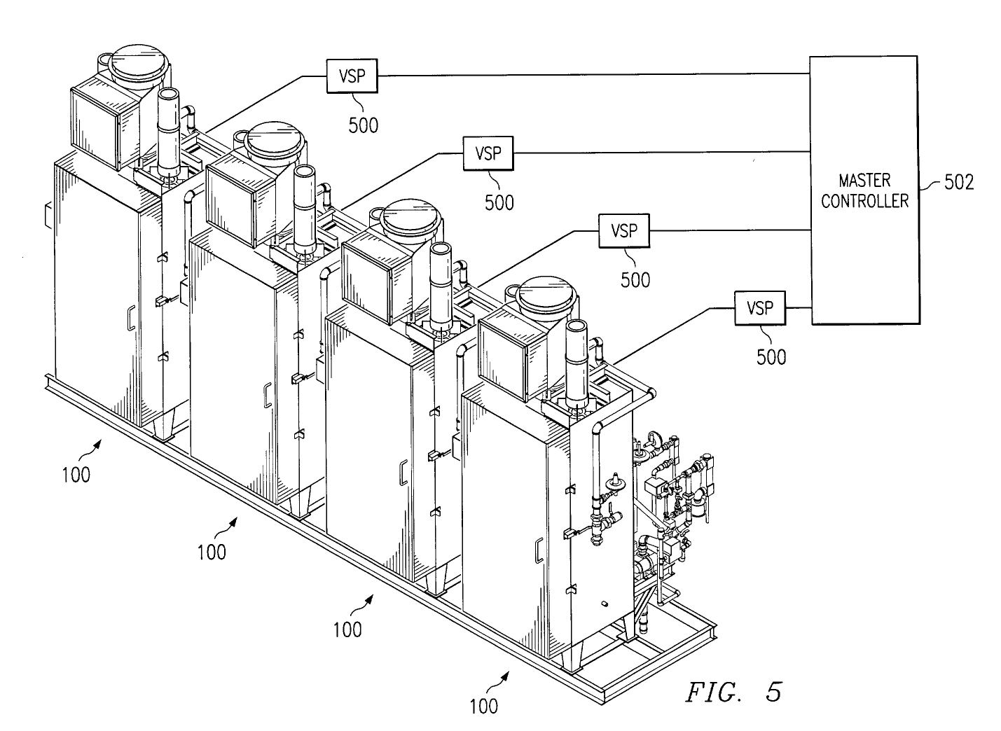

Variable speed pump 108 may be any suitable variable speed pump that functions to turn down the capacity of gas generator 100 to a desired output. In one embodiment, variable speed pump 108 allows a five-to-one turndown ratio for gas generator 100. The use of variable speed pump 108 in another embodiment of the present invention is described in greater detail below in conjunction with FIG. 5.

Process system 110 includes a plurality of pipes, valves, and other process components that function to transport air and natural gas to, and endothermic gas from, gas generator 100. Any suitable configuration of process system 110 may be used to obtain the desired processing parameters for gas generator 100.

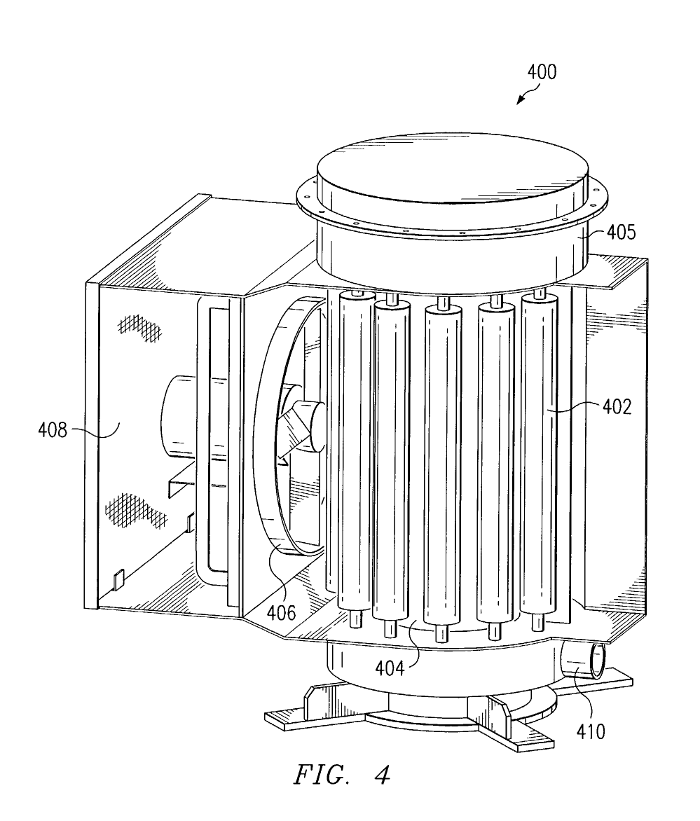

Heat exchanger 400, which is described in greater detail below in conjunction with FIG. 4, functions to cool the gas exiting retort 104 down to approximately 200° F. and freezes the chemistry of the gas exiting retort 104 so that it can be used in downstream systems. Accordingly, heat exchanger 400 is disposed on a top of combustion chamber 102.

A general operation of one embodiment of gas generator 100 is as follows: retort 104 is filled with one or more types of catalyst and disposed within combustion chamber 102. The interior of combustion chamber 102 is then heated via ring burner 106 to a temperature of approximately 1850-1900 degrees Fahrenheit so that retort 104 may be heated to the same temperature. Approximately 2.5 parts of air and 1 part of natural gas enters the bottom of retort 104 and passes upward through the catalyst within retort 104. While traveling up through retort 104, the high temperature of retort 104 in conjunction with the catalyst changes the chemistry of the air-gas mixture such that approximately 1.4 times the original gas volume is produced. The resultant gas then passes out the top of retort 104 into heat exchanger 400 so that the gas may be cooled and the chemistry of the gas frozen. The cooled gas then passes through a gas outlet header to its desired destination, such as a furnace.

FIG. 2 is a perspective view of gas generator 100 illustrating retort 104 being removed from a side of the combustion chamber 102 by utilizing access door 112 according to one embodiment of the present invention. As illustrated in FIG. 2, access door 112 is shown in an “open” position. One way to facilitate the opening of access door 112 is to couple access door 112 to combustion chamber 102 with one or more hinges 202. Other suitable ways of coupling access door 112 to combustion chamber 102 may be utilized. For example, access door 112 may be coupled to combustion chamber 102 with a plurality of fasteners 205, such as bolts and nuts, used in conjunction with associated brackets 206. Other suitable clamping arrangements are contemplated by the present invention. Also illustrated in FIG. 2 is an insulation plug 204 that functions to close combustion chamber 102 to retort 104. Accordingly, a flange associated with insulation plug 204 may be used to hang insulation plug 204 on top of combustion chamber 102, between retort 104 and access door 112. Other suitable arrangements for locating or disposing insulation plug 204 within combustion chamber 102 are contemplated by the present invention.

Because of the importance of the high temperatures associated with gas generator 100, forming combustion chamber 102 with a door is counterintuitive, as a door creates gaps in combustion chamber 102 that would either require additional insulation considerations or reduce the efficiency of ring burner 106.

To remove retort 104 from the side of combustion chamber 102, a structural boom 200 may be utilized. Structural boom 200 includes one or more structural members 210 that are arranged in such a manner that a forklift using one of its forks is able to pick up and manipulate retort 104 to remove retort 104 from combustion chamber 102. Structural boom 200 may be coupled to retort 104 in any suitable manner. In another embodiment, retort 104 may be removed from a side of combustion chamber 102 with a machine that has cylindrical band clamps that are able to grab onto the body of retort 104.

Also shown more clearly in FIG. 2 is an open bottom 208 of combustion chamber 102. This is how ambient air enters the interior of combustion chamber 102. However, as described above, the ambient air first passes through recuperator 300 and is preheated before entering the interior of combustion chamber 102. This is described in greater detail below in conjunction with FIGS. 3A and 3B.

FIG. 3A is a front perspective view, and FIG. 3B an elevation view, of gas generator 100 showing ring burner 106 and recuperator 300 in more detail. FIGS. 3A and 3B illustrate only one of many possible configurations of recuperator 300. As described above, recuperator 300 functions to preheat ambient air traveling into the interior of combustion chamber 102 to a temperature of approximately 600° F. One way that recuperator 300 facilitates this preheating is to prevent ambient air from traveling in a direct path into the interior of combustion chamber 102 from outside open bottom 208 of combustion chamber 102. This direct path is illustrated by dashed arrow 301 in FIG. 3A. Previous gas generators allowed ambient air to travel in the direction of dashed arrow 301, which resulted in an inefficient gas burner.

Referring to FIGS. 3A and 3B, recuperator 300 includes a plurality of substantially horizontal plates 304 each separated by a distance 314 that is equal to approximately three to four inches. Although four plates 304 are shown in FIGS. 3A and 3B, any suitable number of plates may be utilized and plates 304 may be separated by any suitable distance 314. In the illustrated embodiment, the bottom three plates of recuperator 300 have chamfers 308 formed on opposite corners to facilitate ambient air to travel in a generally boustrophedonic manner, as clearly shown in FIG. 3B. Accordingly, all of the plates 304 except the plate that's closest to combustion chamber 102 have chamfers 308 at opposite corners and the plates are staggered such that the air is forced to travel in a direction indicated by arrows 310. When ambient air reaches the underside of the top plate 304 the preheated air enters the interior of combustion chamber 102 via a plurality of holes 306 that are formed in the top plate 304. This is indicated by arrows 312 in FIG. 3B. Any suitable number of holes 306 having any suitable diameter may be utilized in the top plate. Thus, preheating ambient air via recuperator 300 before it enters the interior of combustion chamber 102 results in a technical advantage of improved efficiency of ring burner 106, which reduces costs associated with gas generator 100.

Also illustrated in FIG. 3A is a plurality of nozzles 302 associated with ring burner 106. Nozzles 302 have flames emanating therefrom that function to heat the interior of combustion chamber 102. Any suitable number of nozzles 302 having any suitable diameter may be utilized.

FIG. 4 is a perspective view of heat exchanger 400 for use with gas generator 100 according to one embodiment of the present invention. Heat exchanger 400 includes a plurality of fin tubes 402 surrounding a chamber 404, a cooling fan 406, a filter 408, and an gas outlet 410. As described above, heat exchanger 400 functions to cool the gas exiting retort 104 down to a suitable temperature, such as 200° F. Heat exchanger 400 also functions to freeze the chemistry of the gas exiting retort 104.

Fin tubes 402 are generally cylindrical in nature and function to transport gas therethrough while ambient air is blown over the exterior of fin tubes 402 so that the gas traveling therein may be cooled down. Fin tubes 402 may be any suitable diameter and any suitable length and may be formed from any suitable material.

Chamber 404 is illustrated in FIG. 4 to be a cylinder that is coupled at a lower end thereof to the outlet of retort 104. Chamber 404 transports the gas exiting from retort 104 into a manifold 405 at the top of heat exchanger 400 so that the gas may then travel downward through fin tubes 402 for cooling. Chamber 404 may have any suitable diameter and may be formed from any suitable material.

Cooling fan 406 functions to blow ambient air over fin tubes 402 to facilitate the cooling of the gas flowing therethrough. Cooling fan 406 may be any suitable fan driven by any suitable motor and may be formed from any suitable material. Filter 408 functions to filter the air entering heat exchanger 400 and may be any suitable air filter.

Gas outlet 410 collects and delivers the cooled gas exiting fin tubes 402 and delivers it to a gas outlet header so that it may be delivered to a furnace or other suitable structure or system. Gas outlet 410 may be any suitable configuration and may be formed from any suitable material.

A technical advantage of one embodiment of heat exchanger 400 is that the gas exiting retort 104 travels vertically upward through chamber 404 before making an approximately 180° turn downward through fin tubes 402 where the gas is cooled by cooling fan 406. This prevents any soot that develops during the cooling of the gas from dropping into retort 104. This reduces the frequency of maintenance that's required for retort 104. Any clogging of the retort 104 is also prevented by heat exchanger 400 and this, in turn, keeps the efficiency of retort 104 at acceptable levels.

FIG. 5 is a perspective view of a plurality of gas generators 100 each having a variable speed pump 500 that is coupled to a master controller 502 according to another embodiment of the present invention. A technical advantage of the illustrated embodiment is that each gas generator 100 is designed to be not only a stand-alone gas generator having a separate variable speed pump and separate process systems, but each is also designed to work in tandem with other gas generators to increase the capacity of gas required in addition to maximizing the efficiency of the gas generators. As described further below, master controller 502 facilitates the maximum efficiency of a plurality of gas generators 100. As an example, if each gas generator 100 has a capacity of 3,000 scfh, and 10,000 scfh capacity is required, then a user of gas generators 100 may purchase three more gas generators 100 and put four of them in tandem. Therefore, the maximum capacity of all four gas generators 100 would be 12,000 scfh. Since only 10,000 scfh is required, master controller 502, as described further below, turns down one of the gas generators 100 from a capacity of 3,000 scfh to 1,000 scfh to obtain the 10,000 scfh total.

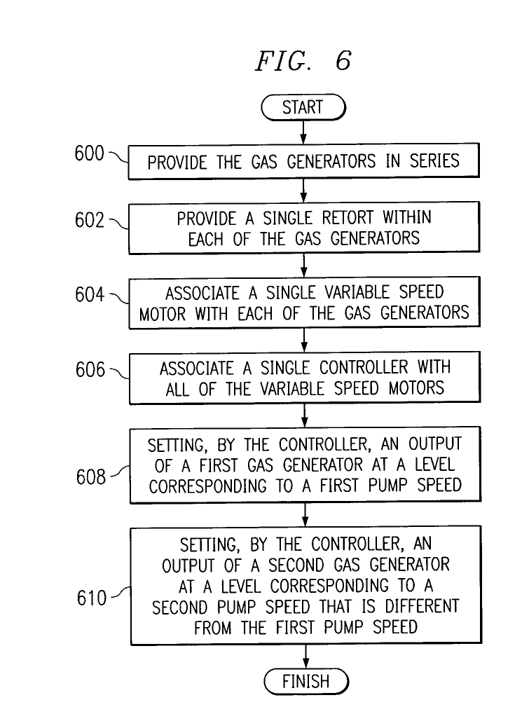

To further illustrate the advantage of the configuration shown in FIG. 5, continuing with the example above, if the required capacity drops from 10,000 scfh to 8,000 scfh, then the generator that was turned down to 1,000 scfh is then turned down further to 600 scfh, which is approximately 20% of its maximum capacity, by master controller 502. Then a second gas generator is turned down from 3,000 scfh to 1,400 scfh, which means that two gas generators 100 are running at full capacity, one gas generator is running at 600 scfh, and the remaining gas generator 100 is running at 1,400 scfh. Master controller 502 contains an input from a suitable pressure transmitter monitoring the pressure at the outlet of the respective gas generator 100. Master controller 502 controls the turndown profile of each of the gas generators 100 to maintain the pressure at the specified value. One example of master controller 502 is a Honeywell UMC 800 controller. To illustrate an example method of the embodiment of FIG. 5, a flowchart is provided in FIG. 6.

FIG. 6 is a flowchart illustrating a method of controlling the output for a plurality of gas generators 100 according to one embodiment of the present invention. The method begins at step 600 where a plurality of gas generators 100 are provided in series. Each of gas generators 100 are provided, at step 602, with a single retort 104. A single variable speed pump 500 is associated with each gas generator 100 at step 604, and a single master controller 502 is associated with all of the variable speed pumps at step 606. Master controller 502 is then utilized at step 608 to set the output of a first gas generator 100 of the plurality of gas generators to a level corresponding to a first pump speed of its variable speed pump 500. Master controller 502 is then utilized at step 610 to set the output of a second gas generator 100 at a level corresponding to a second pump speed of its variable speed pump 500 that may be different than the first pump speed. This ends the example method of controlling an output of a plurality of gas generators 100. The method outlined in FIG. 6 covers the example described above where a required output of approximately 8,000 scfh is required. A technical advantage of the method outlined in FIG. 6 is that gas generators 100 may be used as “plug-and-play” modules in which each gas generator 100 may function as a stand alone unit or may work in tandem with other gas generators 100 to increase the capacity of gas that is available. In the latter case, master controller 502 maximizes the efficiency of a plurality of gas generators 100 that are working in tandem.

Although embodiments of the invention and their advantages are described in detail, a person skilled in the art could make various alterations, additions, and omissions without departing from the spirit and scope of the present invention as defined by the appended claims.

What is claimed is:

1. A gas generator system, comprising:
a generally rectangular combustion chamber having insulation coupled to an inside surface thereof;
an elongated retort having catalyst therein substantially vertically disposed within the combustion chamber;
an access door coupled to a side of the combustion chamber, the access door adapted to allow removal of the retort from the side of the combustion chamber;
a recuperator disposed proximate an open bottom of the combustion chamber, the recuperator adapted to prevent air from travelling in a direct path into the combustion chamber from outside the open bottom of the combustion chamber; and
a heat exchanger disposed on a top of the combustion chamber, the heat exchanger comprising:
a chamber;
a plurality of fin tubes surrounding the chamber;
a manifold coupled the chamber and the fin tubes; and
a fan operable to direct ambient air over the fin tubes.

2. A gas generator system, comprising:
a combustion chamber having insulation coupled to an inside surface thereof;
a retort, having catalyst disposed therein, disposed within the combustion chamber; and
an access door coupled to a side of the combustion chamber, the access door adapted to allow removal of the retort from the side of the combustion chamber.

3. The system of claim 2, further comprising a boom adapted to selectively couple to the retort to aid in removal of the retort from the side of the combustion chamber.

4. The system of claim 3, wherein the boom is configured to accept a fork of a forklift to aid in removal of the retort from the side of the combustion chamber.

5. The system of claim 2, wherein the access door is hinged to the side of the combustion chamber with one or more hinges.

6. The system of claim 2, wherein the access door is fastened to the side of the combustion chamber with a plurality of fasteners.

7. The system of claim 2, further comprising a recuperator disposed proximate an open bottom of the combustion chamber, the recuperator adapted to prevent air from travelling in a direct path into the combustion chamber from outside the open bottom of the combustion chamber.

8. The system of claim 7, wherein the recuperator comprises a plurality of substantially horizontal plates.

9. The system of claim 8, wherein each plate has a surface area that is slightly less than an area defined by an inside perimeter of the insulation coupled to the combustion chamber.

10. The system of claim 8, wherein the plate that is closest to the inside of the combustion chamber includes a plurality of apertures formed therein.

11. A gas generator system, comprising:
a combustion chamber having insulation coupled to an inside surface thereof;
a retort, having catalyst therein, disposed within the combustion chamber; and
a recuperator disposed proximate an open bottom of the combustion chamber, the recuperator adapted to prevent air from travelling in a direct path into the combustion chamber from outside the open bottom of the combustion chamber.

12. The system of claim 11, wherein the recuperator is adapted to preheat the air travelling into the combustion chamber to a temperature of at least approximately 600 degrees Fahrenheit.

13. The system of claim 11, wherein the recuperator comprises a plurality of substantially horizontal plates.

14. The system of claim 13, wherein each plate has a surface area that is slightly less than an area defined by an inside perimeter of the insulation coupled to the combustion chamber.

15. The system of claim 13, wherein the plate that is closest to the inside of the combustion chamber includes a plurality of apertures formed therein.

16. The system of claim 13, wherein the plate that is closest to the inside of the combustion chamber includes a plurality of apertures formed therein and the remaining plates are arranged such that the air travelling into the combustion chamber from outside the open bottom of the combustion chamber travels in a generally boustrophedonic manner.

17. The system of claim 11, further comprising an access door coupled to a side of the combustion chamber, the access door adapted to allow removal of the retort from the side of the combustion chamber.

18. The system of claim 11, wherein the access door is hinged to the side of the combustion chamber with one or more hinges.

19. The system of claim 11, wherein the access door is fastened to the side of the combustion chamber with a plurality of fasteners.

20. The system of claim 17, further comprising a boom adapted to selectively couple to the retort to aid in removal of the retort from the side of the combustion chamber.

21. A gas generator system, comprising:
a generally rectangular combustion chamber having insulation coupled to an inside surface thereof;
an elongated retort having catalyst therein substantially vertically disposed within the combustion chamber;
an access door coupled to a side of the combustion chamber, the access door adapted to allow removal of the retort from the side of the combustion chamber; and
a recuperator disposed proximate an open bottom of the combustion chamber, the recuperator adapted to prevent air from travelling in a direct path into the combustion chamber from outside the open bottom of the combustion chamber.

22. The system of claim 21, wherein the access door is hinged to the side of the combustion chamber with one or more hinges.

23. The system of claim 21, wherein the access door is fastened to the side of the combustion chamber with a plurality of fasteners.

24. The system of claim 21, wherein the recuperator comprises a plurality of substantially horizontal plates arranged such that air travelling into the combustion chamber from outside the open bottom of the combustion chamber travels in a generally boustrophedonic manner.

25. The system of claim 21, further comprising a boom adapted to selectively couple to the retort to aid in removal of the retort from the side of the combustion chamber.

26. A method of cooling a gas mixture exiting a retort of a gas generator, comprising:
providing a heat exchanger on a top of a combustion chamber of the gas generator, the heat exchanger including a chamber and a plurality of fin tubes surrounding the chamber;
delivering the gas mixture from the retort upward into the chamber;
directing the gas downward through the fin tubes; and
directing ambient air by a fan over an exterior surface of each fin tube to cool the gas mixture, whereby any soot that develops during the cooling of the gas mixture is prevented from dropping into the retort.

27. The method of claim 26, further comprising directing the gas mixture, after it has been cooled, to a outlet header coupled to the heat exchanger.

28. A method of controlling an output for a plurality of gas generators, comprising:
providing the gas generators in series;
providing a single retort within each of the gas generators;
associating a single variable speed pump with each of the gas generators;
associating a single controller with all of the variable speed pumps;
setting, by the controller, an output of a first gas generator of the plurality of gas generators at a level corresponding to a first pump speed; and
setting, by the controller, an output of a second gas generator of the plurality of gas generators at a level corresponding to a second pump speed that is different from the first pump speed.

29. The method of claim 28, wherein setting the output of a first gas generator comprises setting, by the controller, the output of the first gas generator at no less than twenty percent.

30. The method of claim 28, wherein setting the output of the second gas generator comprises setting, by the controller, the output of the second gas generator at a level corresponding to a second pump speed after the output of the first gas generator has been set, by the controller, to no less than twenty percent.
